(19) United States
(12) Patent Application Publication
(10) Pub. No.: US 2008/0102403 A1
(43) Pub. Date: May 1, 2008

(54) Photoresist compositions and methods of forming a pattern using the same

(75) Inventors: Seong-June Kim, Hwaseong-si (KR); Kyoung-Mi Kim, Anyang-si (KR); Jae-Ho Kim, Yongin-si (KR); Young-Ho Kim, Yongin-si (KR); Seok Han, Hwaseong-si (KR); Hyo-Jin Yun, Anyang-si (KR)

Correspondence Address: MILLS & ONELLO LLP, ELEVEN BEACON STREET, SUITE 605, BOSTON, MA, 02108, US

(73) Assignee: Samsung Electronics Co., LTD., Suwon-si (KR)

(21) Appl. No.: 11/977,893

(22) Filed: Oct. 26, 2007

(30) Foreign Application Priority Data
Oct. 27, 2006 (KR) 10-2006-0104912

(51) Int. Cl. G03C 1/00

(52) U.S. Cl. 430/270.1

(57) ABSTRACT

A photoresist-composition includes about 4 to about 20 percent by weight of an acrylate copolymer; about 0.1 to about 0.5 percent by weight of a photoacid generator; and a solvent. The acrylate copolymer includes about 28 to about 38 percent by mole of a first repeating unit represented by Formula (1), about 28 to about 38 percent by mole of a second repeating unit represented by Formula (2), about 0.5 to about 22 percent by mole of a third repeating unit represented by Formula (3) and about 4 to about 42 percent by mole of a fourth repeating unit represented by Formula (4),

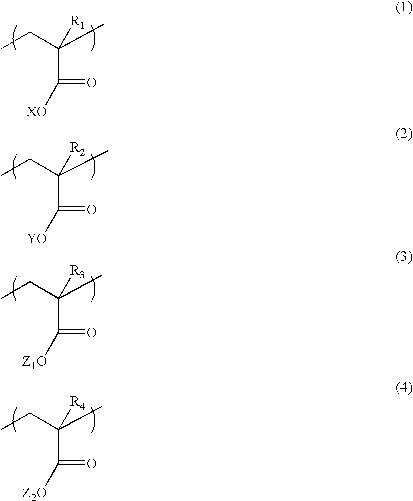

wherein R₁, R₂, R₃ and R₄ independently represent a hydrogen atom or a C₁-C₃ alkyl group, X is a blocking group including an alkyl-substituted adamantane or an alkyl-substituted tricycloalkane, Y is a blocking group including a lactone, Z₁ is a blocking group including a hydroxyl-substituted adamantane, and Z₂ is a blocking group including an alkoxy-substituted adamantane.

### CROSS-REFERENCE TO RELATED APPLICATIONS

This application claims priority under 35 U.S.C. §119 to Korean Patent Application No. 10-2006-0104912, filed on Oct. 27, 2006, the contents of which are herein incorporated by reference in their entireties.

### FIELD OF THE INVENTION

The present invention relates to photoresist compositions and methods of forming a pattern using the photoresist compositions. The photoresist compositions may be used for manufacturing a semiconductor device, for example.

### BACKGROUND

As semiconductor devices become more highly integrated and operate at higher speeds, methods of forming a very fine pattern having a line width below about 80 nm have been desired. In some cases, a photolithography process using a photoresist is utilized to form a pattern of a semiconductor device. The photolithography process can include a photoresist coating process, an alignment process, an exposure process and/or a developing process.

The photoresist has a molecular structure that may be altered by incident light irradiated thereto, and a photoresist film is formed by coating a substrate with such a photoresist. A photomask on which an electronic circuit pattern is formed is arranged over the substrate where the photoresist film is formed by the alignment process. Then, an illuminating light having an appropriate wavelength is provided to the photoresist film so as to generate a photochemical reaction in an exposed portion of the photoresist film. As a result, a predetermined electronic circuit pattern may be transcribed onto the photoresist film by the alignment and the exposure processes. The exposed portion of the photoresist film, which corresponds to the predetermined electronic circuit pattern, has an altered molecular structure. The photoresist film having the altered molecular structures is selectively removed by the developing process to form a photoresist pattern on the substrate. While the developing process is performed, the exposed portion of the photoresist film may be selectively removed from the substrate, or may selectively remain on the substrate. As a result, a photoresist pattern having a shape corresponding to that of the predetermined electronic circuit pattern can be formed on the substrate.

A minimal line width of the photoresist pattern is determined by the resolution of an exposing system. The resolution of the exposing system is determined by a wavelength of the incident light according to the Rayleigh's equation as follows:

R=k₁λ/NA

where λ denotes a wavelength of the incident light of an exposing system, R denotes a resolution limit of the exposing system, k₁ denotes a proportional constant of the exposing process, and NA denotes a numerical aperture of a lens of the exposing process. According to the Rayleigh's equation, the wavelength λ of the incident light and the proportional constant k₁ need to be as small as possible, and the numerical aperture of a lens NA needs to be as; large as possible to decrease the resolution limit of the exposing system. As the wavelength of the incident light becomes shorter, the resolution of the exposing system is improved and the line width of the photoresist pattern is reduced. Thus, the wavelength of the incident light, the exposing system and the resolution limit of the photoresist should be considered in forming a fine photoresist pattern.

A photoresist is generally classified as a negative photoresist or a positive photoresist. In some embodiments, in an exposed portion of the positive photoresist, a blocking group of a photosensitive polymer is detached by an acid that is generated from a photoacid generator. The photosensitive polymer, from which the blocking group is removed, may be readily dissolved into a developing solution during the developing process.

As an example, a photoresist pattern, in which an opening having a width of about 100 nm is formed, may be prepared by forming a preliminary photoresist pattern having an opening with a width of about 180 nm, and then by performing a flow baking process on the preliminary photoresist pattern. A conventionally used ArF photoresist can be flowed at a high temperature, for example, at least 160° C., because the conventionally used ArF photoresist has a high glass transition temperature. The temperature of the flow baking process is proportional to a glass transition temperature of the photoresist. For example, the flow baking process can be performed at a temperature about 5° C. higher than the glass transition temperature of the photoresist. However, the photoresist pattern formed by performing the flow baking process at the high temperature can have a non-uniform critical dimension (CD). The non-uniform critical dimension of the photoresist pattern may cause poor uniformity of the pattern. Thus, generation of a defect in a semiconductor device, such as a transistor, a capacitor and the like, may increase, and a production yield of a semiconductor manufacturing process may decrease.

### SUMMARY OF THE INVENTION

Embodiments of the present invention relate to photoresist compositions that may be employed in forming a photoresist pattern by a flow baking process, which may be performed at a low temperature, e.g., substantially lower than about 160° C.

Embodiments of the present invention also relate to methods of forming a pattern having a uniform critical dimension by using the photoresist compositions described herein.

According to one aspect of the present invention, a photoresist composition includes about 4 to about 20 percent by weight of an acrylate copolymer, about 0.1 to about 0.5 percent by weight of a photoacid generator and a solvent. The acrylate copolymer includes about 28 to about 38 percent by mole of a first repeating unit represented by Formula (1), about 28 to about 38 percent by mole of a second repeating unit represented by Formula (2), about 0.5 to about 22 percent by mole of a third repeating unit represented by Formula (3) and about 4 to about 42 percent by mole of a fourth repeating unit represented by Formula (4),

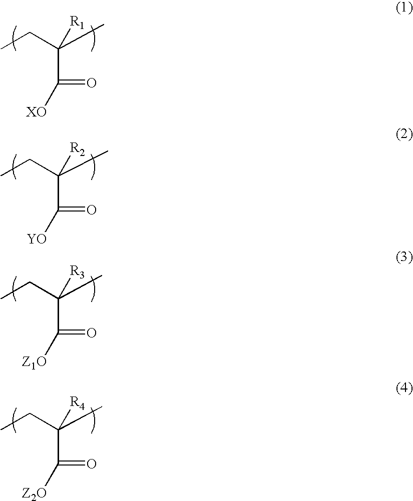

wherein R₁, R₂, R₃ and R₄ independently represent a hydrogen atom or a C₁-C₃ alkyl group, X is a blocking group including an alkyl-substituted adamantane or an alkyl-substituted tricycloalkane, Y is a blocking group including a lactone, Z₁ is a blocking group including a hydroxyl-substituted adamantane, and Z₂ is a blocking group including an alkoxy-substituted adamantane.

In some embodiments, the acrylate copolymer may be a graft, random, alternate or block copolymer of the first to the fourth repeating units.

Examples of the first repeating unit include compounds represented by Formulae (1-1), (1-2) and (1-3),

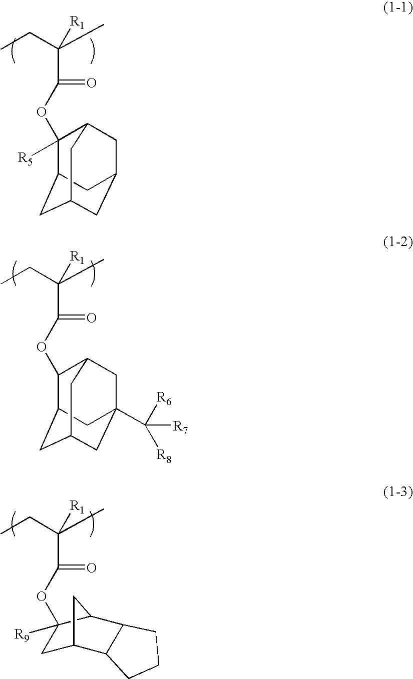

wherein R₁ represents a hydrogen atom or a C₁-C₃ alkyl group, and R₅, R₆, R₇, R₈ and R₉ independently represent a C₁-C₄ alkyl group.

Examples of the second repeating unit include compounds represented by Formulae (2-1) and (2-2),

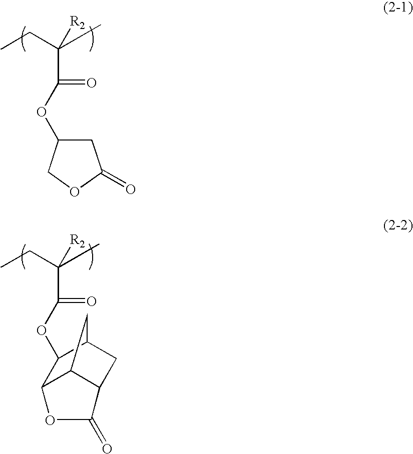

wherein R₂ represents a hydrogen atom or a C₁-C₃ alkyl group.

Examples of the third repeating unit may include compounds represented by Formulae (3-1) and (3-2), and examples of the fourth repeating unit may include compounds represented by Formulae (4-1) and (4-2),

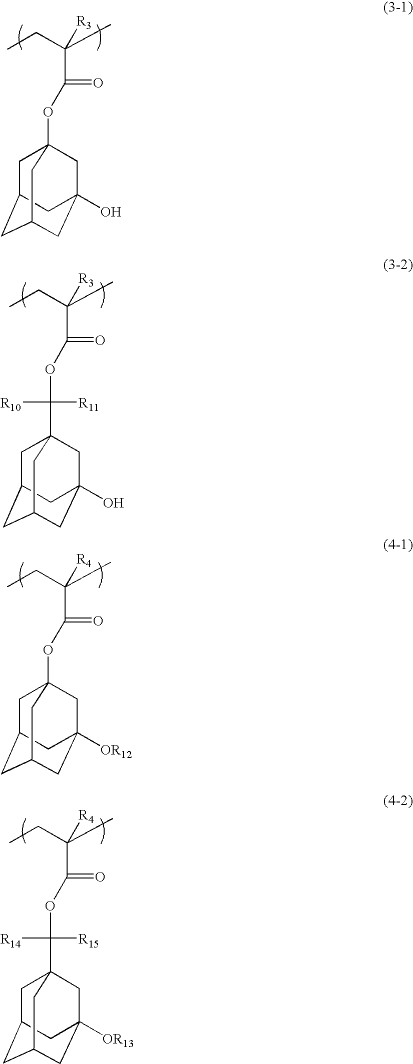

wherein R₃ and R₄ independently represent a hydrogen atom or a C₁-C₃ alkyl group, R₁₀, R₁₁, R₁₄ and R₁₅ independently represent a hydrogen atom or a C₁-C₄ alkyl group, and R₁₂ and R₁₃ independently represent a C₁-C₄ alkyl group.

The acrylate copolymer may have an average molecular weight of about 7,000 to about 13,000, and/or a glass transition temperature in a range of about 130° C. to about 160° C.

According to another aspect of the present invention, there is provided a method of forming a pattern. In the method, a photoresist film is formed with a photoresist composition including about 4 to about 20 percent by weight of an acrylate copolymer, about 0.1 to about 0.5 percent by weight of a photoacid generator and a solvent. At least a portion of the photoresist film is exposed to light, and the film is developed using a developing solution to form a first photoresist pattern. Flow baking is performed on the first photoresist pattern to form a second photoresist pattern. The acrylate copolymer can include about 28 to about 38 percent by mole of a first repeating unit represented by Formula (1), about 28 to about 38 percent by mole of a second repeating unit represented by Formula (2), about 0.5 to about 22 percent by mole of a third repeating unit represented by Formula (3) and about 4 to about 42 percent by mole of a fourth repeating unit represented by Formula (4).

The flow baking process may be performed at a temperature range of about 140° C. to about 160° C.

The acrylate copolymer may include about 31 to about 36 percent by mole of the first repeating unit represented by Formula (1-1), about 31 to about 36 percent by mole of the second repeating unit represented by Formula (2-1), about 0.8 to about 12 percent by mole of the third repeating unit represented by Formula (3-1) and about 18 to about 36 percent by mole of the fourth repeating unit represented by Formula (4-1),

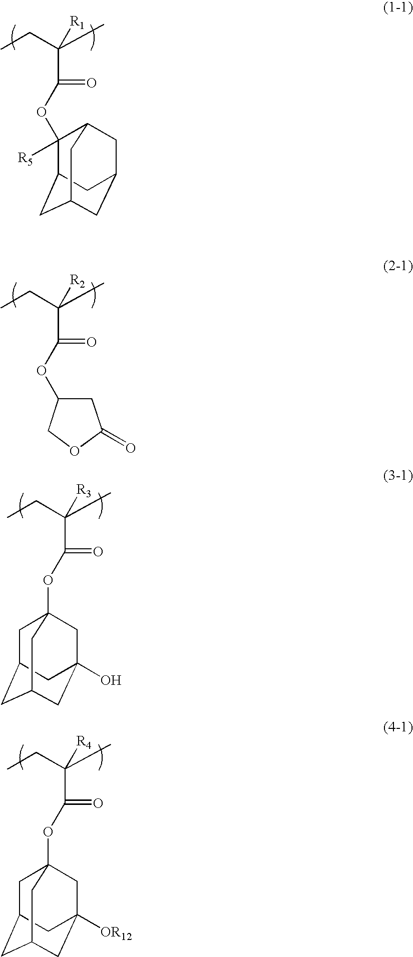

wherein R₁, R₂, R₃ and R₄ independently represent a hydrogen atom or a C₁-C₃ alkyl group, R₅ and R₁₂ independently represent a C₁-C₄ alkyl group.

The photoresist composition can include the acrylate copolymer having a hydroxyl-substituted repeating unit in a range of about 0.5 to about 22 percent by mole based on a total mole of the repeating units. Accordingly, the photoresist composition may reduce or suppress a hydrogen bonding of the acrylate copolymer chains, and the acrylate copolymer may have a glass transition temperature substantially lower than about 160° C.

Therefore, when a photoresist pattern is formed using the photoresist composition including such an acrylate copolymer, the flow baking process may be performed at a temperature substantially lower than about 160° C. Furthermore, the photoresist composition may improve the uniformity of a critical dimension of the photoresist pattern, and may enhance the profile of the photoresist pattern.

As used herein, “alkyl group” includes unsubstituted and substituted alkyl groups.

### BRIEF DESCRIPTION OF THE DRAWINGS

The above and other features and advantages of the present invention will become more apparent by describing in example embodiments thereof with reference to the accompanying drawings, in which:

FIGS. 1 to 4 are cross-sectional views illustrating a method of forming a pattern in accordance with embodiments of the present invention;

FIG. 5 shows SEM pictures illustrating photoresist patterns formed using the photoresist compositions prepared in Examples 1 to 3 and Comparative Example 1;

FIG. 6 is an SEM picture illustrating a photoresist pattern having an opening on which a flow baking process was not performed; and

FIG. 7 shows SEM pictures illustrating photoresist patterns flowed at about 155° C.

### DESCRIPTION OF THE INVENTION

The present invention is described more fully hereinafter with reference to the accompanying drawings, in which embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (e.g., rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Photoresist Composition

A photoresist composition of the present invention is a polymeric material used for forming a photoresist pattern on an object. The photoresist composition includes an acrylate polymer that may react with an acid generated from a photoacid generator, a photoacid generator and a solvent.

The acrylate copolymer included in the photoresist composition may be decomposed by an acid, and then may be readily dissolved in an alkaline developing solution. The acrylate copolymer may include an acid-labile group or a blocking group, which is attached to a main chain and/or a side chain of the acrylate copolymer. The blocking group may be detached from the acrylate copolymer by a reaction with an acid.

The acrylate copolymer is a copolymer of (meth)acrylate repeating units, each of which contains a different blocking group. Examples of the blocking group that may be easily detached from a main chain of the copolymer include an alkyl-substituted adamantane, an alkyl-substituted cycloalkane, a lactone, a hydroxyl-substituted adamantane and an alkoxy-substituted adamantane.

Particularly, the acrylate copolymer can include a first repeating unit having an alkyl-substituted adamantane or an alkyl-substituted tricycloalkane as a blocking group, a second repeating unit having a lactone as a blocking group, a third repeating unit having a hydroxyl-substituted adamantane as a blocking group, and a fourth repeating unit having an alkoxy-substituted adamantane as a blocking group.

The first repeating unit of the acrylate copolymer may be represented by Formula (1),

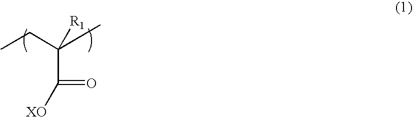

wherein R₁ may represent a hydrogen atom or a C₁-C₃ alkyl group such as a methyl group, an ethyl group or a propyl group, and X may be a blocking group including an alkyl-substituted adamantane or an alkyl-substituted tricycloalkane.

Examples of the first repeating unit that may be used in the acrylate copolymer may include compounds represented by Formulae (1-1), (1-2) and (1-3),

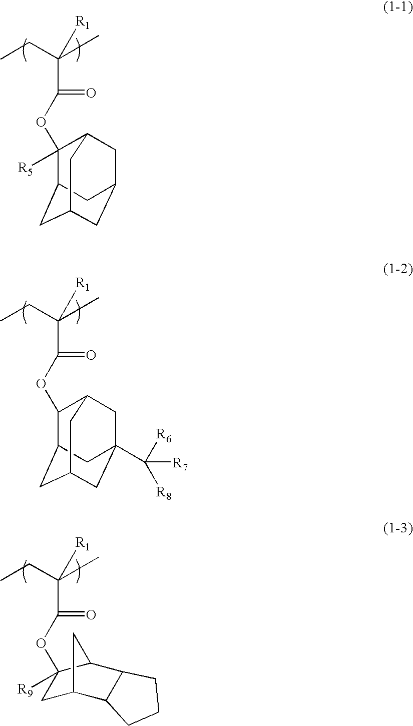

wherein R₁ represents a hydrogen atom or a C₁-C₃ alkyl group, and R₅, R₆, R₇, R₈ and R₉ independently represent a C₁-C₄ alkyl group such as a methyl group, an ethyl group, a propyl group or a butyl group.

The second repeating unit of the acrylate copolymer may be represented by Formula (2),

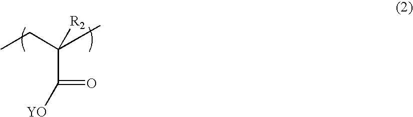

wherein R₂ represents a hydrogen atom or a C₁-C₃ alkyl group, and Y is a blocking group including a lactone.

Examples of the second repeating unit that may be used in the acrylate copolymer include compounds represented by Formulae (2-1) and (2-2),

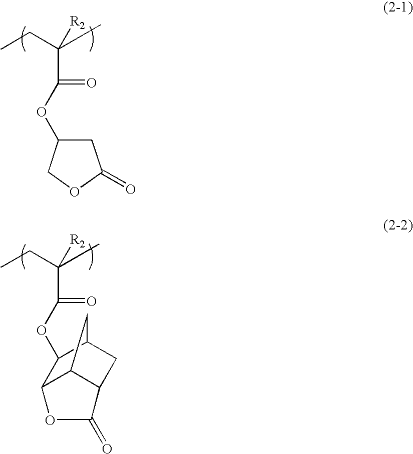

wherein R₂ represents a hydrogen atom or a C₁-C₃ alkyl group such as a methyl group, an ethyl group or a propyl group.

Examples of the second repeating unit also include compounds represented by Formulae (2-3), (2-4), (2-5), (2-6), (2-7), (2-8), (2-9), (2-10), (2-11), (2-12), (2-13), (2-14) and (2-15),

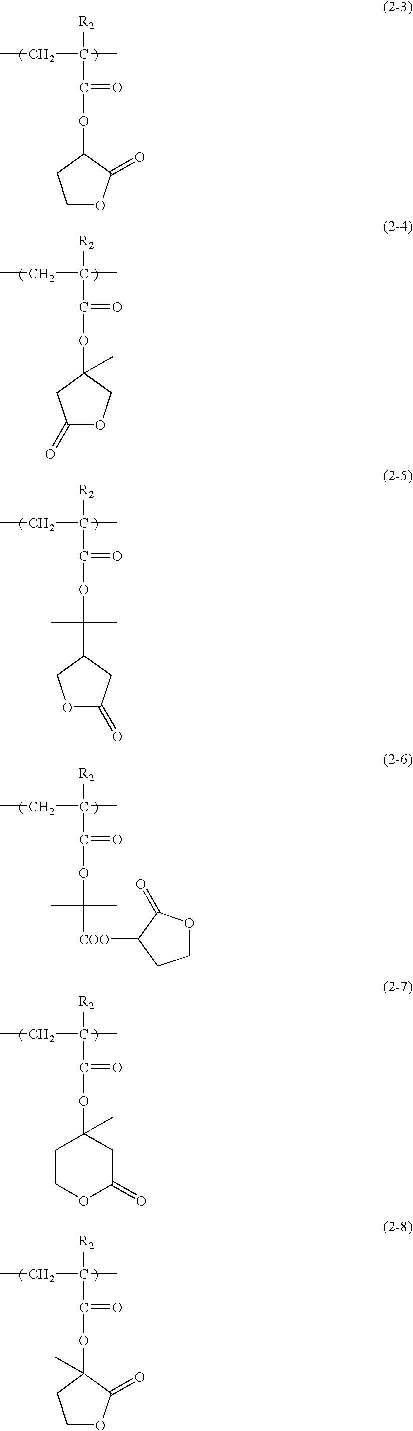

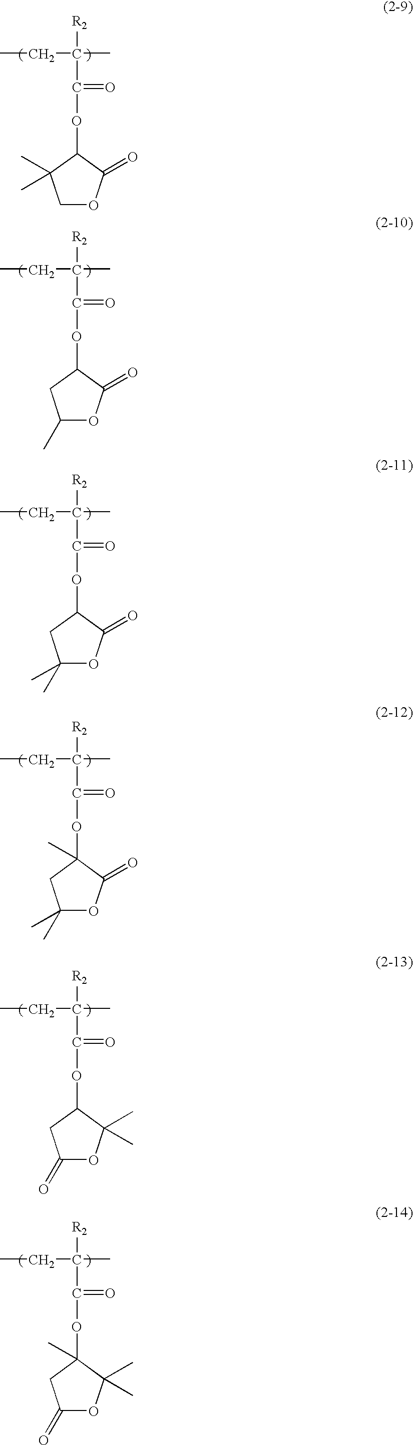

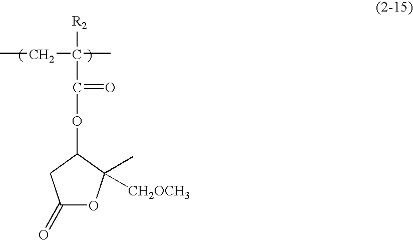

wherein R₂ represents a hydrogen atom or a C₁-C₃ alkyl group such as a methyl group, an ethyl group or a propyl group.

The third repeating unit of the acrylate copolymer may be represented by Formula (3),

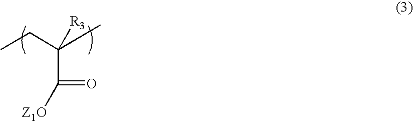

wherein R₃ represents a hydrogen atom or a C₁-C₃ alkyl group, and Z₁ is a blocking group including a hydroxyl-substituted adamantane.

Examples of the third repeating unit include compounds represented by Formulae (3-1) and (3-2),

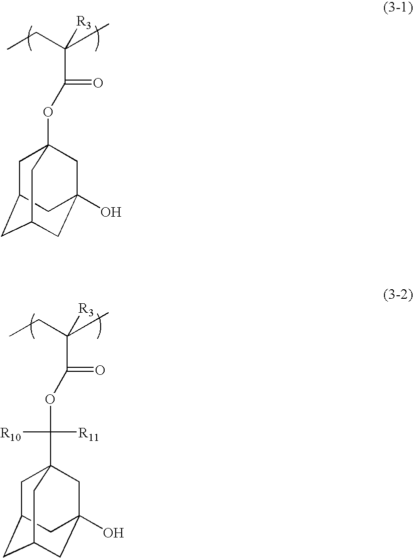

wherein R₃ represents a hydrogen atom or a C₁-C₃ alkyl group such as a methyl group, an ethyl group or a propyl group, R₁₀ and R₁₁ independently represent a hydrogen atom or a C₁-C₄ alkyl group such as a methyl group, an ethyl group, a propyl group or a butyl group.

The fourth repeating unit of the acrylate copolymer may be represented by Formula (4),

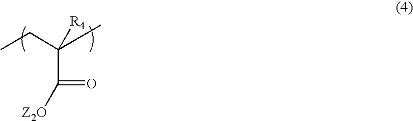

wherein R₄ represents a hydrogen atom or a C₁-C₃ alkyl group, and Z₂ is a blocking group including an alkoxy-substituted adamantane.

Examples of the fourth repeating unit that may be used in the acrylate copolymer include compounds represented by Formulae (4-1) and (4-2),

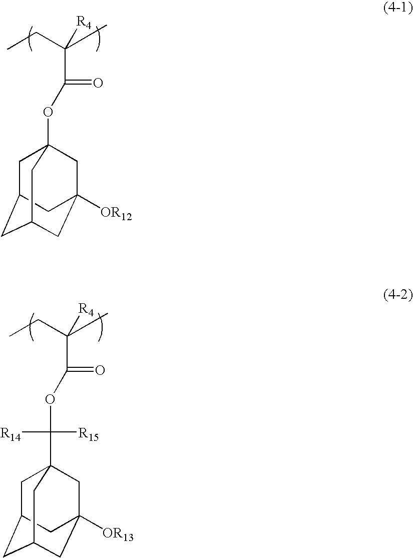

wherein R₄ represents a hydrogen atom or a C₁-C₃ alkyl group, R₁₂ and R₁₃ independently represent a C₁-C₄ alkyl group, and R₁₄ and R₁₅ independently represent a hydrogen atom or a C₁-C₄ alkyl group.

In some embodiments, the acrylate copolymer in the photoresist composition includes about 28 to about 38 percent by mole of the first repeating unit represented by Formula (1), about 28 to about 38 percent by mole of the second repeating unit represented by Formula (2), about 0.5 to about 22 percent by mole of the third repeating unit represented by Formula (3) and about 4 to about 42 percent by mole of the fourth repeating unit represented by Formula (4).

The acrylate copolymer including the above-mentioned repeating units may have a glass transition temperature substantially lower than that of a methacrylate polymer that has at least 25 percent by mole of a hydroxyl-substituted repeating unit. In some embodiments, the acrylate copolymer has a glass transition temperature in a range of about 130° C. to about 160° C., for example, in a range of about 130° C. to about 150° C. The acrylate copolymer may have an average molecular weight of about 7,000 to about 13,000, for example, about 8,000 to about 12,000.

When the amounts of the first and the second repeating units are less than about 28 percent by mole or greater than about 38 percent by mole, the photoresist composition may not form a photoresist pattern having desired properties and a uniform profile. Therefore, the acrylate copolymer may include the first and the second repeating units in a range of about 28 to about 38 percent by mole, for example, about 31 to about 36 percent by mole.

When the amount of the third repeating unit is less than about 0.5 percent by mole, a portion of a hydroxyl-substituted repeating unit in the acrylate copolymer is so small that the acrylate copolymer may have an excessively low hydrophilicity and a reaction of the acrylate copolymer with an acid generated from the photoacid generator may be reduced. In addition, when the amount of the third repeating unit is greater than about 22 percent by mole, a portion of the hydroxyl-substituted repeating unit may excessively increase and hydrogen bonding between chains of the acrylate copolymer may form more frequently. An increase of the hydrogen bonding may result in an increase of the glass transition temperature of photoresist. Therefore, the acrylate copolymer may include the third repeating unit in a range of about 0.5 to about 22 percent by mole, for example, about 0.8 to about 12 percent by mole.

When the amount of the fourth repeating unit is less than about 4 percent by mole, a portion of the hydroxyl-substituted repeating unit may increase and the glass transition temperature of the acrylate copolymer may also rise to at least about 160° C. Additionally, when the amount of the fourth repeating unit is greater than about 42 percent by mole, a portion of the hydroxyl-substituted repeating unit may be so relatively small that the acrylate copolymer may have a low hydrophilicity and a reaction of the acrylate copolymer with an acid may be reduced. Thus, in some embodiments, the acrylate copolymer includes the fourth repeating unit in a range of about 4 to about 42 percent by mole, for example, about 18 to about 36 percent by mole.

The acrylate copolymer included in the photoresist composition may have a reduced amount of a hydroxyl-substituted repeating unit and an increased amount of an alkoxy-substituted repeating unit, for example, compared with another methacrylate polymer. Therefore, the acrylate copolymer may reduce or suppress the hydrogen bonding of polymer chains owing to a decrease of a hydroxyl group and an increase of an alkoxy group. Accordingly, the acrylate copolymer may have a glass transition temperature in a range of about 130° C. to about 160° C., which is substantially lower than a glass transition temperature of an acrylate copolymer having a large portion of a hydroxyl-substituted repeating unit. Therefore, when a photoresist pattern is formed using the photoresist composition, the uniformity of a critical dimension may be improved due to the low temperature of a flow baking process.

When the amount of the acrylate copolymer is less than about 4 percent by weight, a photoresist pattern may not have sufficient etching resistance. Additionally, when the amount of the acrylate copolymer is greater than about 20 percent by weight, a thickness uniformity of a photoresist film may be deteriorated. Thus, the photoresist composition can include about 4 to about 20 percent by weight of the acrylate copolymer.

When the amount of the photoacid generator is less than about 0.1 percent by weight, less acid may be generated during the exposure process, and the blocking group may not sufficiently detach from the acrylate copolymer. Additionally, when the amount of the photoacid generator is greater than about 0.5 percent by weight, the acid may be excessively generated so that an increased amount of a top portion of a photoresist pattern may be removed during the developing process.

Therefore, the photoresist composition may include the photoacid generator in a range of about 0.1 to about 0.5 percent by weight, for example, in a range of 0.15 to about 0.4 percent by weight.

Examples of the photoacid generator include a triarylsulfonium salt, a diarylsulfonium salt, a sulfonate, N-hydroxysuccinimide triflate, etc. Other examples of the photoacid generator may include triphenylsulfonium triflate, triphenylsulfonium antimony salt, diphenyliodonium triflate, diphenyliodonium antimony salt, methoxydiphenyliodonium triflate, di-tert-butyldiphenyliodonium triflate, 2,6-dinitrobenzyl sulfonate, pyrogallol tris(alkylsulfonate), norbornene dicarboximide triflate, triphenylsulfonium nonaflate, diphenyliodonium nonaflate, methoxydiphenyliodonium nonaflate, di-tert-butyldiphenyliodonium nonaflate, N-hydroxysuccinimide nonaflate, norbornene dicarboximide nonaflate, triphenylsulfonium perfluorooctanesulfonate, diphenyliodonium perfluorooctanesulfonate, methoxyphenyliodonium perfluorooctanesulfonate, di-tert-butyldiphenyliodonium triflate, N-hydroxysuccinimide perfluorooctanesulfonate, norbornene dicarboximide perfluorooctanesulfonate, etc. The photoresist composition can include one or more photoacid generators.

Examples of the organic solvent that may be used in the photoresist composition include ethylene glycol monomethyl ether, ethylene glycol monoethyl ether, propylene glycol methyl ether, methyl cellosolve acetate, ethyl cellosolve acetate, diethylene glycol monomethyl ether, diethylene glycol monoethyl ether, propyleneglycol methyl ether acetate, propylene glycol propyl ether acetate, diethylene glycol dimethyl ether, ethyl lactate, toluene, xylene, methyl ethyl ketone, cyclohexanone, 2-heptanone, 3-heptanone, 4-heptanone, etc. The photoresist composition can include one or more organic solvents. An amount of the organic solvent may vary in accordance with components of the photoresist composition. For example, the photoresist composition may include the organic solvent in a range of about 79.5 to about 95.9 percent by weight.

In some embodiments, the photoresist composition further includes an additive in order to improve characteristics of the photoresist composition. Examples of additives include an organic base and/or a surfactant. The organic base may prevent a basic compound, such as an amine in the air, from affecting a photoresist pattern obtained after the exposure process, and thus the organic base may maintain or adjust the shape of a photoresist pattern. Examples of the-organic base include triethylamine, triisobutylamine, triisooctylamine, triisodecylamine, diethanolamine, triethanolamine, etc. One or more organic bases can be included in the photoresist composition. The surfactant may improve coatability of the photoresist composition and prevent the formation of striations on a photoresist film. Examples of the surfactant include fluorine-containing surfactants, such as SURFLON SC-103, SR-100 (trade names manufactured by Asahi Glass Co., Ltd., Japan), EF-361 (trade names manufactured by Tohoku Hiryou K.K., Japan), FLORAD Fc-431, Fc-135, Fc-98, and Fc-176 (trade names manufactured by Sumitomo 3M Ltd., Japan), etc. For example, the photoresist composition may include the additive such as the organic base and/or the surfactant in a range of about 0.001 to about 10 percent by weight. When the photoresist composition includes the additive, the photoresist composition may include the organic solvent in a range of about 69.5 to about 95.899 percent by weight.

Method of Forming a Pattern

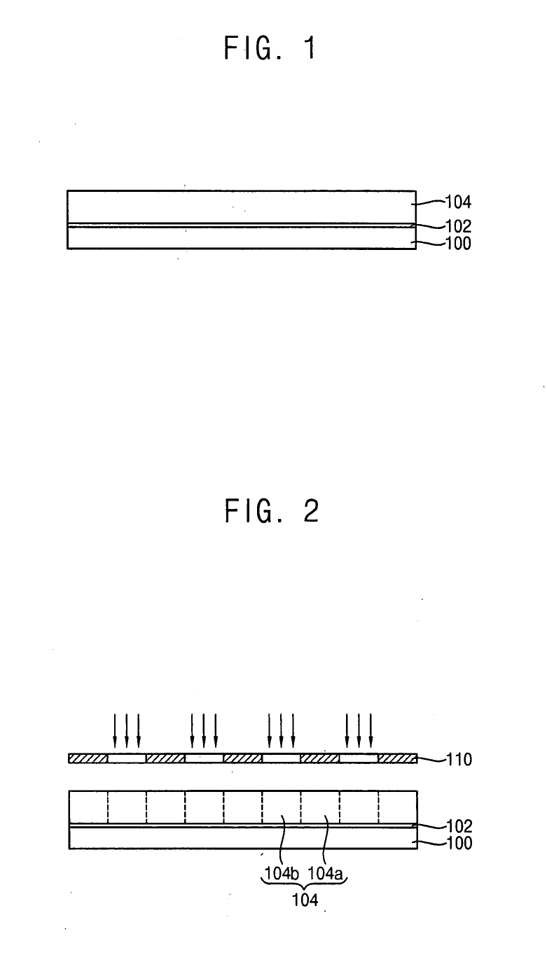

FIGS. 1 to 4.are cross-sectional views illustrating a method of forming a pattern in accordance with embodiments of the present invention.

Referring to FIG. 1, an object to be etched is prepared. Examples of the object may include a semiconductor substrate and a thin film 102 formed on a substrate 100. Examples of the thin film 102 may include a silicon nitride layer, a polysilicon layer, a silicon oxide layer, a metal layer, etc.

The substrate 100 including the thin film 102 may be cleaned so as to remove contaminants from the thin film 102. A photoresist film 104 is formed on the thin film 102 by coating the thin film 102 with a photoresist composition including about 4 to about 20 percent by weight of an acrylate copolymer, about 0.1 to about 0.5 percent by weight of a photoacid generator and a remainder of a solvent.

The acrylate copolymer includes about 28 to about 38 percent by mole of a first repeating unit represented by Formula (1), about 28 to about 38 percent by mole of a second repeating unit represented by Formula (2), about 0.5 to about 22 percent by mole of a third repeating unit represented by Formula (3) and about 4 to about 42 percent by mole of a fourth repeating unit represented by Formula (4),

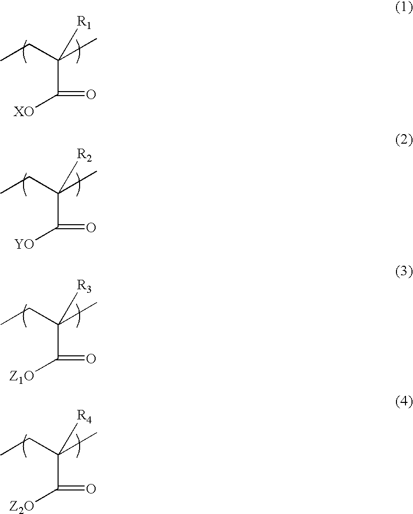

wherein R₁, R₂, R₃ and R₄ independently represent a hydrogen atom or a C₁-C₃ alkyl group, X is a blocking group including an alkyl-substituted adamantane or an alkyl-substituted tricycloalkane, Y is a blocking group including a lactone, Z₁ is a blocking group including a hydroxyl-substituted adamantane, and Z₂ is a blocking group including an alkoxy-substituted adamantane.

The acrylate copolymer including the above-mentioned repeating units may have a glass transition temperature substantially lower than that of a methacrylate polymer that has at least 25 percent by mole of a hydroxyl-substituted repeating unit. Particularly, the acrylate copolymer including the above-mentioned repeating units may have a glass transition temperature in a range of 130° C. to about 160° C., for example, in a range of 130° C. to about 150° C. The acrylate copolymer may have an average molecular weight of about 7,000 to about 13,000, for example, about 8,000 to about 12,000.

In some embodiments, the substrate 100 on which the photoresist film 104 is formed may be thermally treated in, a first baking process. The first baking process may be performed, for example, at a temperature of about 90° C. to about 120° C. In the first baking process, adhesion between the photoresist film 104 and the thin film 102 may be enhanced.

Referring to FIG. 2, the photoresist film 104 is partially exposed to light in an exposure process. As shown, a mask 110 having a predetermined pattern may be positioned on a mask stage of an exposure apparatus, and then the mask 110 is aligned over the photoresist film 104. An unmasked portion of the photoresist film 104 formed on the substrate 100 may be selectively reacted with light transmitted through the mask 110 while the light irradiates on the mask 110 for a predetermined time period.

Examples of the light that may be used in the exposure process include an ArF laser having a wavelength of about 193 nm, a KrF laser having a wavelength of about 248 nm, an F₂ laser, an Hg-Xe light, etc. An exposed portion 104b of the photoresist film 104 may be more hydrophilic than an unexposed portion 104a of the photoresist film 104. Accordingly, the exposed portion 104b and the unexposed portion 104a of the photoresist film 104 may have different solubilities.

Subsequently, a second baking process may be performed on the substrate 100. The second baking process may be performed, for example, at a temperature of about 90° C. to about 150° C. In the second baking process, the exposed portion 104b of the photoresist film 104 may become soluble in a developing solution.

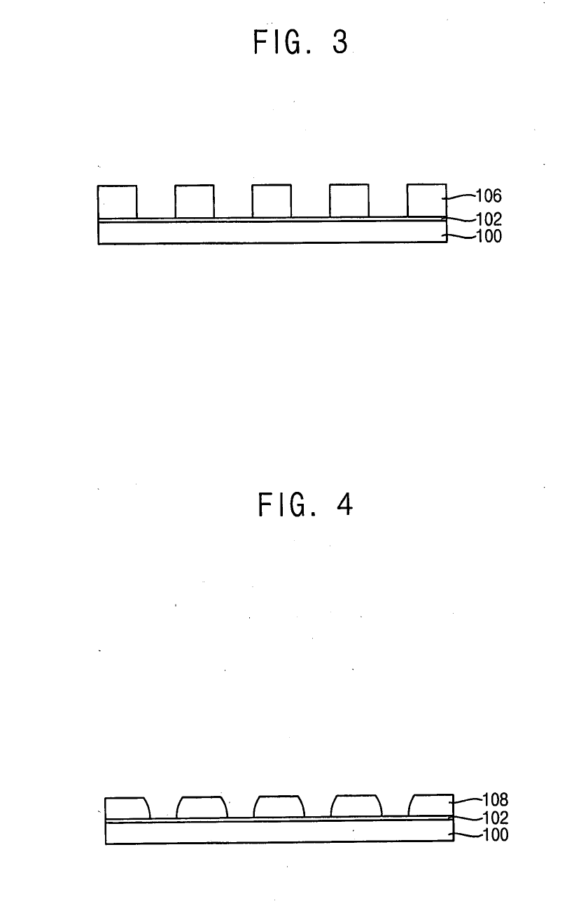

Referring to FIG. 3, a first photoresist pattern 106 is formed by dissolving the exposed portion 104b of the photoresist film 104 into a developing solution to remove the exposed portion 104b from the photoresist film 104. For example, the exposed portion 104b of the photoresist film 104 may be removed by dissolving the exposed portion 104b into an aqueous solution of tetramethylammonium hydroxide. The hydrophilicities in the unexposed and the exposed portions 104a and 104b of the photoresist film 104 are different from each other, and thus the exposed portion 104b of the photoresist film 104 may be selectively removed by being dissolved in the developing solution. Subsequently, the substrate 100 having the first photoresist pattern 106 may be rinsed and dried to complete the first photoresist pattern 106 having an opening of a first width. For example, the opening of the first photoresist pattern 106 has a width of about 120 nm to about 200 nm.

Referring to FIG. 4, a flow baking process is performed on the first photoresist pattern 106 to form a second photoresist pattern 108 having an opening of a second width. The second width of the second photoresist pattern 108 may be substantially smaller than the first width of the first photoresist pattern 106.

The flow baking process may be carried out by thermally treating the first photoresist pattern 106 at least once. The flow baking process may be performed at a temperature substantially equal to or higher than a glass transition temperature of the acrylate copolymer. For example, the flow baking process may be conducted at a temperature about 5° C. higher than the glass transition temperature of the acrylate copolymer. In some embodiments, the flow baking process may be performed at a temperature of about 140° C. to about 160° C., for example at about 145° C. to about 155° C. In the flow baking process, the top portion of the first photoresist pattern 106 may flow to reduce the first width of the opening of the first photoresist pattern 106. As a result, the second photoresist pattern 108 may have an opening of the second width that is substantially smaller than the first width. For example, the opening of the second photoresist pattern 108 has a width of about 61 nm to about 135 nm.

Although it is not shown in figures, the thin film 102 is partially etched using the second photoresist pattern 108 as an etching mask to form a thin film pattern on the substrate 100.

The present invention will be described in more detail with reference to examples of preparing a photoresist composition having an acrylate copolymer, a photoacid generator and a solvent, hereinafter. However, it will be understood that the present invention is not limited by the following examples.

Preparation of Photoresist Compositions

### EXAMPLE 1

A photoresist composition was prepared by mixing about 111 parts by weight of a first methacrylate copolymer, about 2 parts by weight of triphenylsulfonium triflate, and about 887 parts by weight of propylene glycol monomethyl ether acetate, and by filtering the mixture using a membrane filter of about 0.2 μm. The first methacrylate copolymer included about 35 percent by mole of a first repeating unit represented by Formula (5), about 35 percent by mole of a second repeating unit represented by Formula (6), about 1 percent by mole of a third repeating unit represented by Formula (7) and about 29 percent by mole of a fourth repeating unit represented by Formula (8), and had a glass transition temperature (Tg) substantially lower than about 150° C.

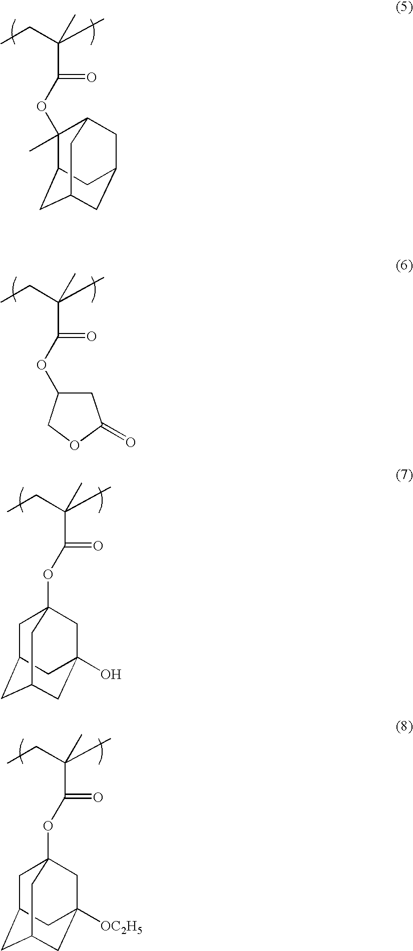

### EXAMPLE 2

A photoresist composition was prepared by performing processes substantially the same as those of Example 1 except that a second methacrylate copolymer was used instead of the first methacrylate copolymer. The second methacrylate copolymer included about 35 percent by mole of the first repeating unit, about 35 percent by mole of the second repeating unit, about 10 percent by mole of the third repeating unit and about 20 percent by mole of the fourth repeating unit, and had a glass transition temperature (Tg) substantially lower than about 150° C.

### EXAMPLE 3

A photoresist composition was prepared by performing processes substantially the same as those of Example 1 except that a third methacrylate copolymer was used instead of the first methacrylate copolymer. The third methacrylate copolymer included about 35 percent by mole of the first repeating unit, about 35 percent by mole of the second repeating unit, about 20 percent by mole of the third repeating unit and about 10 percent by mole of the fourth repeating unit, and had a glass transition temperature (Tg) substantially lower than about 150° C.

### COMPARATIVE EXAMPLE 1

A photoresist composition was prepared by performing processes substantially the same as those of Example 1 except that a fourth methacrylate copolymer was used instead of the first methacrylate copolymer. The fourth methacrylate copolymer included about 35 percent by mole of the first repeating unit, about 35 percent by mole of the second repeating unit, about 25 percent by mole of the third repeating unit and about 5 percent by mole of the fourth repeating unit, and had a glass transition temperature (Tg) substantially higher than about 160° C.

Evaluation of a Resolution of a Photoresist Pattern

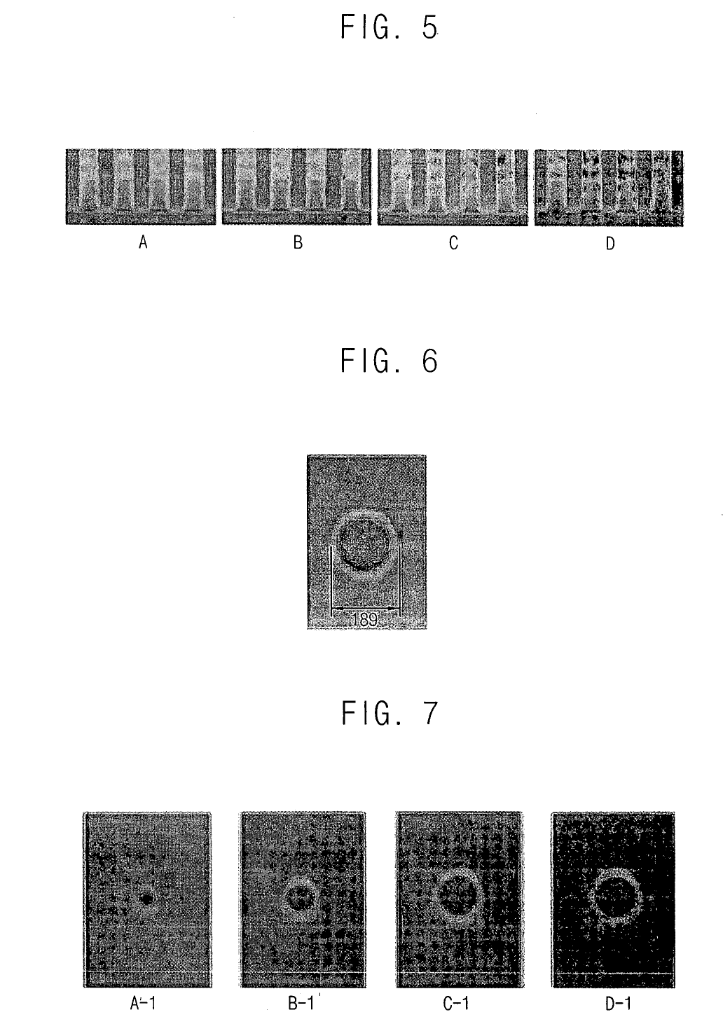

Photoresist films were formed on silicon wafers by coating the silicon wafers with the photoresist compositions prepared in Examples 1 to 3 and Comparative Example 1, and by heating the silicon wafers at a temperature of about 100° C. for about 90 seconds. The photoresist films had a thickness of about 17,000 Å. Thereafter, the photoresist films were selectively exposed to an ArF radiation using a mask, and then thermally treated at a temperature of about 110° C. for about 90 seconds. The exposed portions of the photoresist films were removed from the silicon wafers using a developing solution such as an aqueous solution including 2.38 percent by weight of tetramethylammonium hydroxide (TMAH). The silicon wafers, on which the developing process was performed, were cleaned and dried to complete photoresist patterns formed on the silicon wafers. The photoresist patterns thus obtained were observed using a scanning electron microscope (SEM). The results are shown in FIG. 5. The mask used in the exposure process had patterns having a width of about 90 nm.

FIG. 5 shows SEM pictures illustrating photoresist patterns formed using the photoresist compositions prepared in Examples 1 to 3 and Comparative Example 1. In FIG. 5, the first picture (A), the second picture (B), the third picture (C) and the fourth picture (D) show the photoresist patterns formed using the photoresist compositions prepared in Examples 1 through 3 and Comparative Example 1, respectively,

As shown in FIG. 5, all the photoresist patterns obtained using the photoresist compositions of Examples 1 to 3 and Comparative Example 1 had excellent resolutions. Therefore, although a ratio of a methacrylate repeating unit having a hydroxyl group can decrease, a resolution of a photoresist pattern may not be substantially altered.

Evaluation of Flow Characteristics of a Photoresist Pattern

Photoresist films were formed on silicon wafers by coating the silicon wafers with the photoresist compositions prepared in Examples 1 to 3 and Comparative Example 1, and by heating the silicon wafers at a temperature of about 100° C. for about 90 seconds. The photoresist films had a thickness of about 17,000 Å. Thereafter, the photoresist films were selectively exposed to an ArF radiation using a mask, and then thermally treated at a temperature of about 110° C. for about 90 seconds. The exposed portions of the photoresist films were removed from the silicon wafers using a developing solution such as an aqueous solution including 2.38 percent by weight of tetramethylammonium hydroxide (TMAH). The silicon wafers, on which the developing process was performed, were cleaned and dried to complete photoresist patterns formed on the silicon wafers. The photoresist patterns had openings having a diameter of about 189 nm as shown in an SEM picture of FIG. 6.

The photoresist patterns were baked at temperatures of about 150° C. and about 155° C. for about 90 seconds. While the photoresist patterns were baked at such temperatures, the photoresist patterns flowed to reduce diameters of the openings formed in the photoresist patterns. A change of the diameters of the openings was observed using an SEM. The diameter changes of the openings heated at about 150° C. and about 155° C., and the diameters of the openings heated at about 155° C. are shown in Table 1.

TABLE 1

| | Ratio of Repeating Unit | | | | |
|---|---|---|---|---|---|
| | [mole %] | | Diameter | | |
| | 3^{rd} Repeating | 4^{th} Repeating | Change [nm] | | Diameter |
| | Unit (OH) | Unit (OR) | 150° C. | 155° C. | [nm] |
| Example 1 | 1 | 29 | 59.1 (↓) | 127.8 (↓) | 61.2 |
| Example 2 | 10 | 20 | 29.1 (↓) | 89.3 (↓) | 99.7 |
| Example 3 | 20 | 10 | 14.5 (↓) | 67.9 (↓) | 121.1 |
| Com- | 25 | 5 | 14.3 (↓) | 43.2 (↓) | 145.8 |
| parative | | | | | |
| Example 1 | | | | | |

FIG. 7 shows SEM pictures illustrating photoresist patterns flowed at about 155° C., the photoresist patterns being formed using the photoresist compositions prepared in Examples 1 to 3 and Comparative Example 1. In FIG. 7, the first picture (A-1), the second picture (B-1), the third picture (C-1) and the fourth picture (D-1) show the photoresist patterns formed using the photoresist compositions prepared in Examples 1 through 3 and Comparative Example 1, respectively,

Referring to FIG. 7, the photoresist patterns formed using the photoresist compositions prepared in Examples 1 to 3 showed an improved diameter decrease of at least about 67 nm at about 155° C. However, the photoresist pattern formed using the photoresist compositions prepared in Comparative Example 1 had a small change of less than about 50 nm at about 155° C. Therefore, the photoresist composition including a reduced ratio of a hydroxyl-substituted repeating unit may be advantageously employed in forming a fine photoresist pattern through a flow process.

In some embodiments, the photoresist composition includes the acrylate copolymer having a hydroxyl-substituted repeating unit in a range of about 0.5 to about 22 percent by mole based on a total mole of the repeating units. Accordingly, the photoresist composition may reduce or suppress the hydrogen bonding of the acrylate copolymer chains, and the acrylate copolymer may have a glass transition temperature substantially lower than about 160° C. Therefore, when a photoresist pattern is formed using the photoresist composition including such an acrylate copolymer, the flow baking process may be performed at a temperature substantially lower than about 160° C. Furthermore, the photoresist composition may, improve uniformity of a critical dimension of the photoresist pattern, and may enhance a profile of the photoresist pattern.

The foregoing is illustrative and is not to be construed as limiting thereof. Although a few embodiments have been described, those skilled in the art will readily appreciate that many modifications are possible without materially departing from the novel teachings and advantages of the present invention. Accordingly, all such modifications are intended to be included within the scope of the present invention as defined in the claims. Therefore, it is to be understood that the foregoing is illustrative and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A photoresist composition comprising:
about 4 to about 20 percent by weight of an acrylate copolymer;
about 0.1 to about 0.5 percent by weight of a photoacid generator; and
a solvent,
wherein the acrylate copolymer comprises about 28 to about 38 percent by mole of a first repeating unit represented by Formula (1), about 28 to about 38 percent by mole of a second repeating unit represented by Formula (2), about 0.5 to about 22 percent by mole of a third repeating unit represented by Formula (3) and about 4 to about 42 percent by mole of a fourth repeating unit represented by Formula (4), 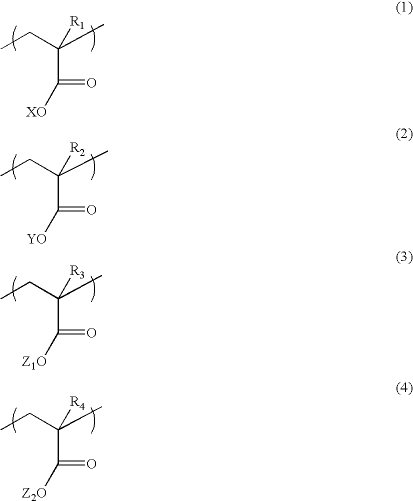
wherein R₁, R₂, R₃ and R₄ independently represent a hydrogen atom or a C₁-C₃ alkyl group, X is a blocking group including an alkyl-substituted adamantane or an alkyl-substituted tricycloalkane, Y is a blocking group including a lactone, Z₁ is a blocking group including a hydroxyl-substituted adamantane, and Z₂ is a blocking group including an alkoxy-substituted adamantane.

2. The photoresist composition of claim 1, wherein the first repeating unit comprises at least one selected from the group consisting of compounds represented by Formulae (1-1), (1-2) and (1-3). 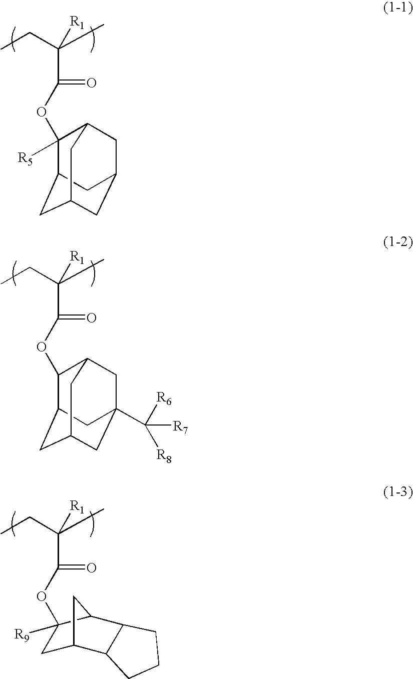
wherein R₁ represents a hydrogen atom or a C₁-C₃ alkyl group, and R₅, R₆, R₇, R₈ and R₉ independently represent a C₁-C₄ alkyl group.

3. The photoresist composition of claim 1, wherein the second repeating unit comprises at least one selected from the group consisting of compounds represented by Formulae (2-1) and (2-2), 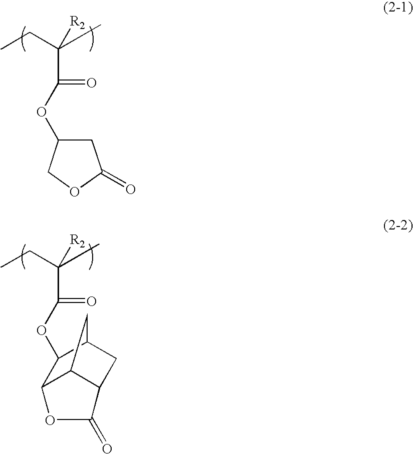
wherein R₂ represents a hydrogen atom or a C₁-C₃ alkyl group.

4. The photoresist composition of claim 1, wherein the third repeating unit comprises at least one selected from the group consisting of compounds represented by Formulae (3-1) and (3-2), and the fourth repeating unit comprises at least one selected from the group consisting of compounds represented by Formulae (4-1) and (4-2), 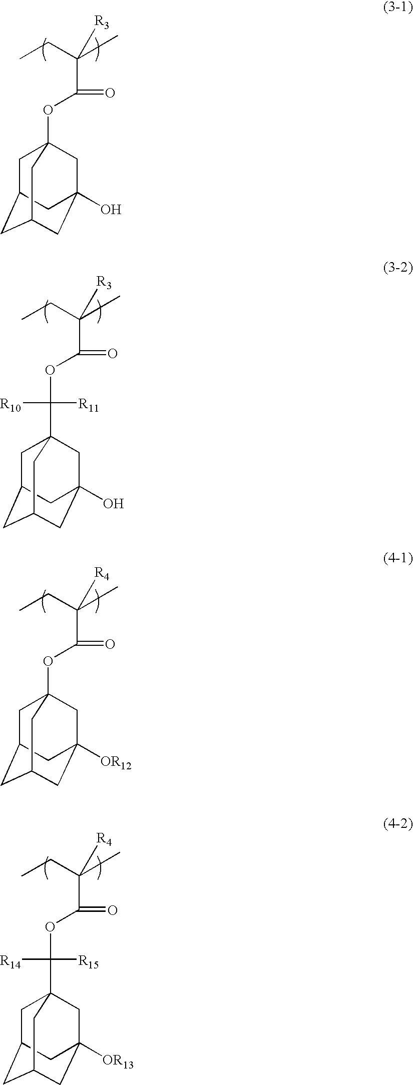
wherein R₃ and R₄ independently represent a hydrogen atom or a C₁-C₃ alkyl group, R₁₀, R₁₁, R₁₄ and R₁₅ independently represent a hydrogen atom or a C₁-C₄ alkyl group, and R₁₂ and R₁₃ independently represent a C₁-C₄ alkyl group.

5. The photoresist composition of claim 1, wherein the acrylate copolymer comprises about 31 to about 36 percent by mole of the first repeating unit, about 31 to about 36 percent by mole of the second repeating unit, about 0.8 to about 12 percent by mole of the third repeating unit and about 18 to about 36 percent by mole of the fourth repeating unit.

6. The photoresist composition of claim 1, wherein the acrylate copolymer has an average molecular weight of about 7,000 to about 13,000.

7. The photoresist composition of claim 1, wherein the acrylate copolymer has a glass transition temperature in a range of about 130° C. to about 160° C.

8. A method of forming a pattern comprising:
forming a photoresist film with a photoresist composition including about 4 to about 20 percent by weight of an acrylate copolymer, about 0.1 to about 0.5 percent by weight of a photoacid generator and a solvent;
exposing at least a portion of the photoresist film to light;
developing the photoresist film using a developing solution to form a first photoresist pattern; and
flow baking the first photoresist pattern to form a second photoresist pattern,
wherein the acrylate copolymer comprises about 28 to about 38 percent by mole of a first repeating unit represented by Formula (1), about 28 to about 38 percent by mole of a second repeating unit represented by Formula (2), about 0.5 to about 22 percent by mole of a third repeating unit represented by Formula (3) and about 4 to about 42 percent by mole of a fourth repeating unit represented by Formula (4), 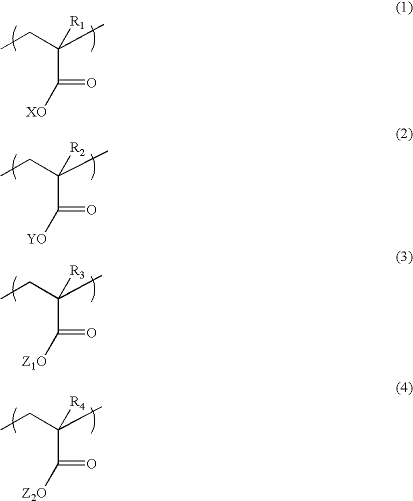
wherein R₁, R₂, R₃ and R₄ independently represent a hydrogen atom or a C₁-C₃ alkyl group, X is a blocking group including an alkyl-substituted adamantane or an alkyl-substituted tricycloalkane, Y is a blocking group including a lactone, Z₁ is a blocking group including a hydroxyl-substituted adamantane, and Z₂ is a blocking group including an alkoxy-substituted adamantane.

9. The method of claim 8, wherein the flow baking is performed at temperature in a range of about 140° C. to 160° C.

10. The method of claim 8, wherein the acrylate copolymer comprises about 31 to about 36 percent by mole of the first repeating unit represented by Formula (1-1), about 31 to about 36 percent by mole of the second repeating unit represented by Formula (2-1), about 0.8 to about 12 percent by mole of the third repeating unit represented by Formula (3-1) and about 18 to about 36 percent by mole of the fourth repeating unit represented by Formula (4-1), 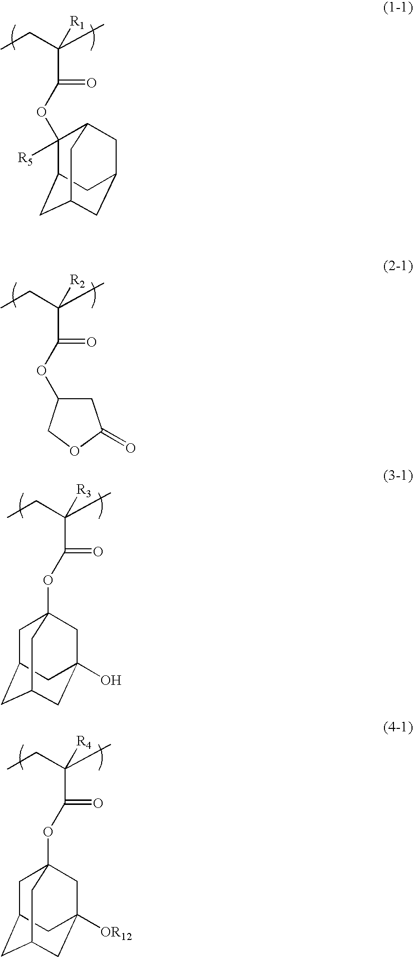
wherein R₁, R₂, R₃ and R₄ independently represent a hydrogen atom or a C₁-C₃ alkyl group, R₅ and R₁₂ independently represent a C₁-C₄ alkyl group.
